(19) United States
(12) Patent Application Publication
(10) Pub. No.: US 2012/0237330 A1
(43) Pub. Date: Sep. 20, 2012

(54) SHELF ALIGNING APPARATUS

(76) Inventor: Mark H. Wensman, San Marcos, CA (US)

(21) Appl. No.: 12/700,690

(22) Filed: Feb. 4, 2010

(51) Int. Cl. A47F 13/06; B25J 1/00

(52) U.S. Cl. 414/800; 254/131

(57) ABSTRACT

According to one embodiment of the present invention, a shelf organizing apparatus is provided. According to this embodiment, the shelf aligning apparatus comprises a flat elongated arm unit having a handle at one end and a hinge at the other end. A trigger is attached to the handle and a flat paddle is attached to the hinge. A cable connects the trigger to the paddle such that in a first position of the trigger, the paddle is aligned in the plane of the arm unit and in a second position of the trigger, the paddle is disposed at an angle with respect to the plane of the arm unit. The shelf organizing apparatus may be used by inserting in between rows of goods when in the first position. Then, with the shelf organizing apparatus in the second position, it may be used to line up the goods in an even row and to pull the row of goods towards the front of the shelf.

### BACKGROUND

The present invention relates to product displays and shelves, and more specifically, to apparatus for organizing and aligning items on shelves.

Most retail businesses use shelves to display products offered for sale. As customers take products from the shelves, gaps are left in the front position of the shelf. Such gaps are undesirable because they make it more difficult for customers to see desired products when the next product on the shelf is located back several inches from the front edge of the shelf. Also, when customers take products off the shelf and sometimes re-shelve products, they may mis-position the products on the shelf, resulting in uneven rows of products on the shelf. Consequently, store employees must spend time organizing and straightening products on shelves. While this can be very time consuming for large stores having tens of thousands of products, it is important for customers to be able to easily see products they want to purchase on the shelves. Straightening products on shelves is also important so that the products look neat and presentable and appealing to customers.

Various attempts have been made to develop devices that facilitate the organizing and straightening of products on shelves. Some of these devices involve spring-loaded racks that keep the products in even rows and also push the products towards the front of the shelve. While, such devices have been employed in some situations, their cost and other disadvantages have prevented their widespread adoption in stores.

### SUMMARY

According to one embodiment of the present invention, an organizing apparatus comprises: a flat elongated arm unit having a handle at one end and a hinge at the other end; a trigger attached to the handle; a flat paddle attached to the hinge; and a cable connecting the trigger to the paddle, wherein in a first position of the trigger, the paddle is aligned in the plane of the arm unit and in a second position of the trigger, the paddle is disposed at an angle with respect to the plane of the arm unit.

According to another embodiment of the present invention, a method for organizing items on a shelf comprises: pulling a trigger on a proximal end of an elongated arm of a shelf organizing apparatus causing a paddle on the distal end of the arm to move to a first position parallel to the arm from a second position at an angle with and towards a first side of the arm; inserting the shelf organizing apparatus between rows of goods on a shelf; releasing the trigger thereby causing the paddle to move from the first position to the second position; and moving the goods toward the front of the shelf using the paddle.

According to another embodiment of the present invention, a handheld organizing apparatus comprises: a flat elongated arm unit having a handle with an opening at one end and a hinge at the other end; a trigger disposed in the opening in the handle; a flat paddle attached to the hinge; a spring attached to the hinge and to the paddle, the spring being biased to bring the trigger and the paddle into a second position; and a cable disposed in a channel within the arm and connecting the trigger to the paddle, wherein in the first position, the paddle is aligned in the plane of the arm unit and in the second position, the paddle is disposed at approximately a 45 degree angle with respect to the plane of the arm unit.

### BRIEF DESCRIPTION OF THE SEVERAL VIEWS OF THE DRAWINGS

FIG. 1 shows a side view of a shelf aligner apparatus in accordance with an embodiment of the invention;

FIG. 2 shows a top view of the shelf aligner apparatus shown in FIG. 1 in first and second positions accordance with an embodiment of the invention;

FIG. 3 shows an enlarged top view of the tip of the shelf aligner shown in FIG. 1 in accordance with an embodiment of the invention;

FIG. 4 shows a side view of a shelf aligner apparatus in accordance with an embodiment of the invention;

FIG. 5a shows a cross sectional view of the arm assembly of the shelf aligner shown in FIG. 1 taken at line 5a-5a in accordance with an embodiment of the invention;

FIG. 5b shows a cross sectional view of the arm assembly of the shelf aligner shown in FIG. 5a taken at line 5b-5b showing cable channels in accordance with an embodiment of the invention;

FIG. 6 shows a side view of a hinge and spring unit of the shelf aligner apparatus shown in FIG. 1 in accordance with an embodiment of the invention;

FIG. 7 shows a side cut-away view of a hinge assembly of the shelf aligner apparatus shown in FIG. 1 in accordance with an embodiment of the invention;

FIG. 8 shows a side view of a hinge and spring unit of the shelf aligner apparatus shown in FIG. 1 in accordance with an embodiment of the invention;

FIG. 9 shows a top cut-away view of the hinge and spring unit of the shelf aligner apparatus shown in FIG. 8 in accordance with an embodiment of the invention;

FIG. 10 shows a perspective view of a portion of the shelf aligner apparatus shown in FIG. 1 in accordance with an embodiment of the invention;

FIG. 11 shows a side view of a portion of the hinge unit of the shelf aligner apparatus shown in FIG. 1 in accordance with an embodiment of the invention;

FIG. 12 shows a top view of a hinge and pulley of the shelf aligner apparatus shown in FIG. 1 in accordance with an embodiment of the invention;

FIG. 13 shows a side view of the handle portion of the shelf aligner apparatus shown in FIG. 1 in accordance with an embodiment of the invention;

FIG. 14 shows a side view of a hinge and spring unit of the shelf aligner apparatus shown in FIG. 1 in accordance with an alternative embodiment of the invention;

FIG. 15 shows a top view of the shelf aligner before use on a shelf containing canned goods in accordance with an embodiment of the invention;

FIG. 16 shows a top view of the shelf aligner after use on a shelf containing canned goods in accordance with an embodiment of the invention;

FIG. 17 shows a left side view of the foldable shelf aligner in an unfolded position in accordance with an embodiment of the invention;

FIG. 18 shows a detail of the left side view of the foldable shelf aligner shown in FIG. 17 in an unfolded position in accordance with an embodiment of the invention;

FIG. 19 shows a detail perspective left side view of the foldable shelf aligner in an unfolded position in accordance with an embodiment of the invention;

FIG. 20 shows a top view of the foldable shelf aligner in a partially folded position in accordance with an embodiment of the invention;

FIG. 21 shows a left side view of the foldable shelf aligner in a fully folded position in accordance with an embodiment of the invention;

FIG. 22 shows a right side view of a portion of the two main sections of the foldable shelf aligner in accordance with an embodiment of the invention; and

FIG. 23 shows a right side view of a portion of the two main sections of the foldable shelf aligner in accordance with an embodiment of the invention.

### DETAILED DESCRIPTION

Embodiments of the invention provide a shelf aligner apparatus for use in straightening and organizing products on a shelf. The shelf aligner apparatus includes an elongated body with a handle portion with a trigger at one end and a hinge at the other end. A paddle member is attached to the hinge which swivels from an angled position when at rest to a straight position when a user squeezes the trigger. The shelf aligner may be inserted by the user between rows of products towards the back of a shelf with the trigger squeezed and the paddle in the straightened position. The user may then release the trigger to cause the paddle to swing to the side. This allow as the user to pull the product towards the front of the shelf.

Previous devices used to align products on shelves relied on the installation of spring-loaded racks. These have proved impractical in many instances due to the cost and the fact that they are not easily adaptable to different sized and different shaped product containers. Such racks also made it more difficult for consumers to re-shelve products, since the next product is immediately pushed toward the front when one product is removed. Additionally, spring loaded racks, based on the space requirements of the device, reduce the sellable area on the shelf, reducing the sales per square foot opportunity.

The present invention instead does not require any device to be installed on the shelf and may be employed at a greatly reduced cost as compared to prior shelf aligning devices. This is because a single shelf aligner in accordance with the invention may be used repeatedly for all shelves instead of requiring a separate device for each shelve. The present invention may also be used in a variety of settings and applications where goods and items are placed on shelves. These include retail stores, warehouses, factories, residences and others.

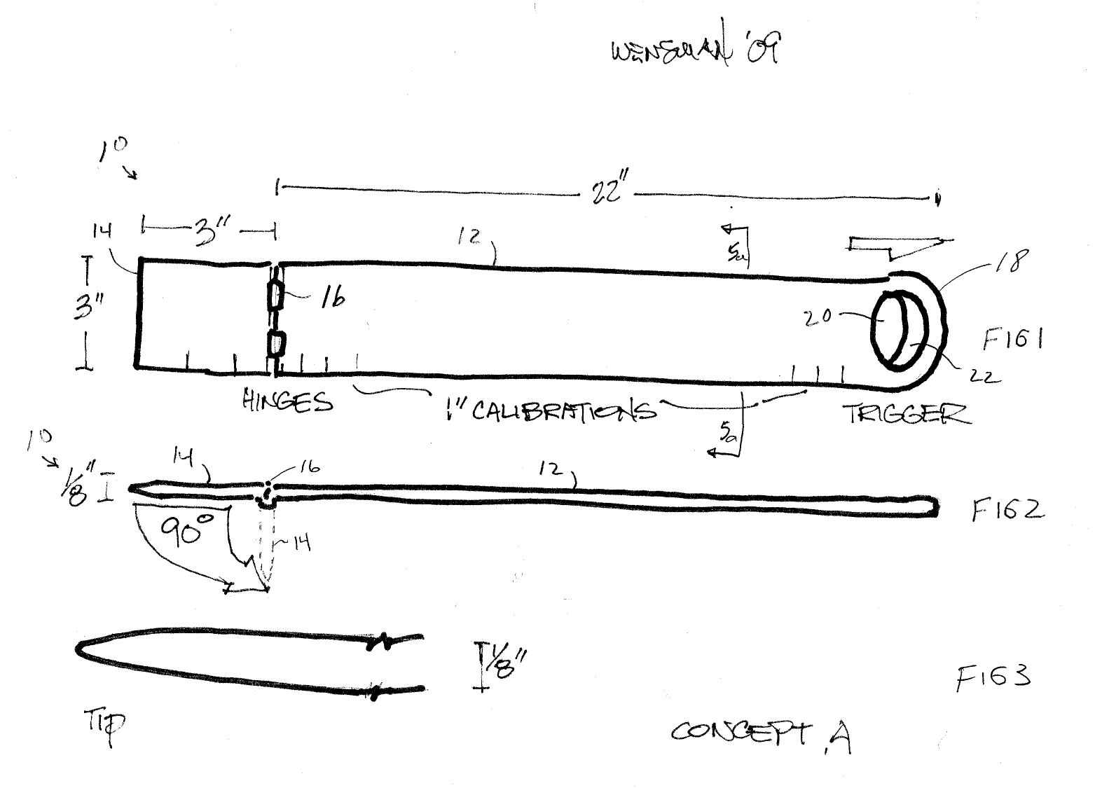

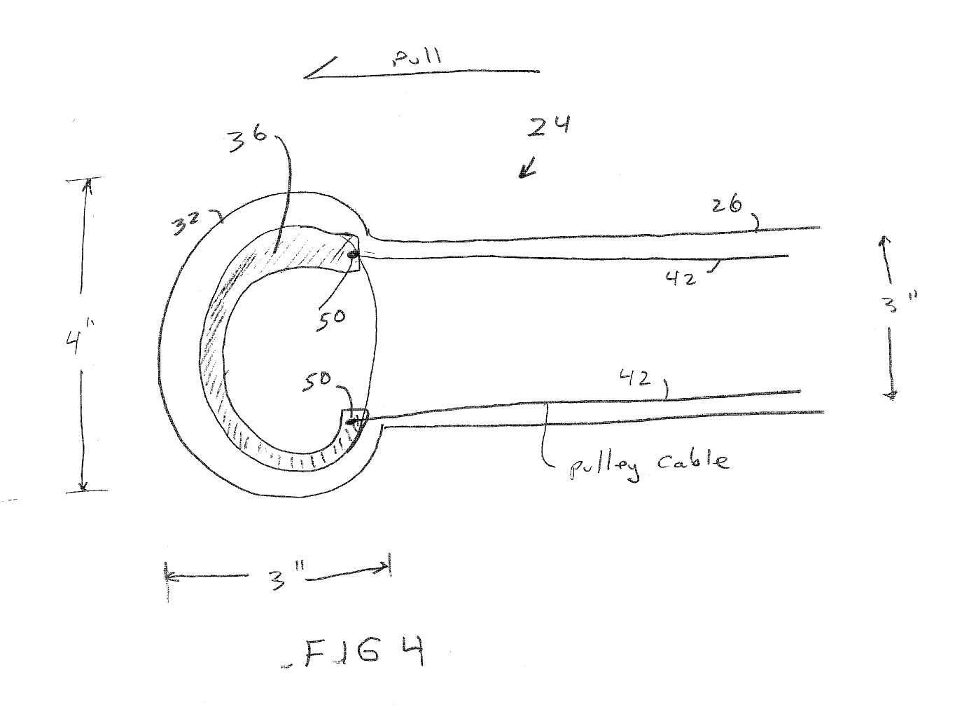

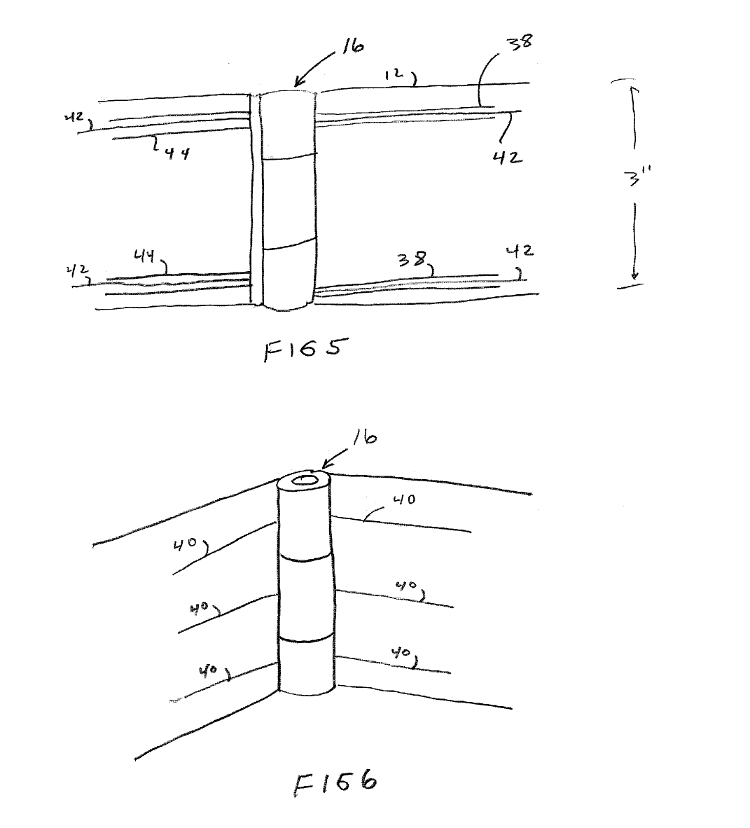

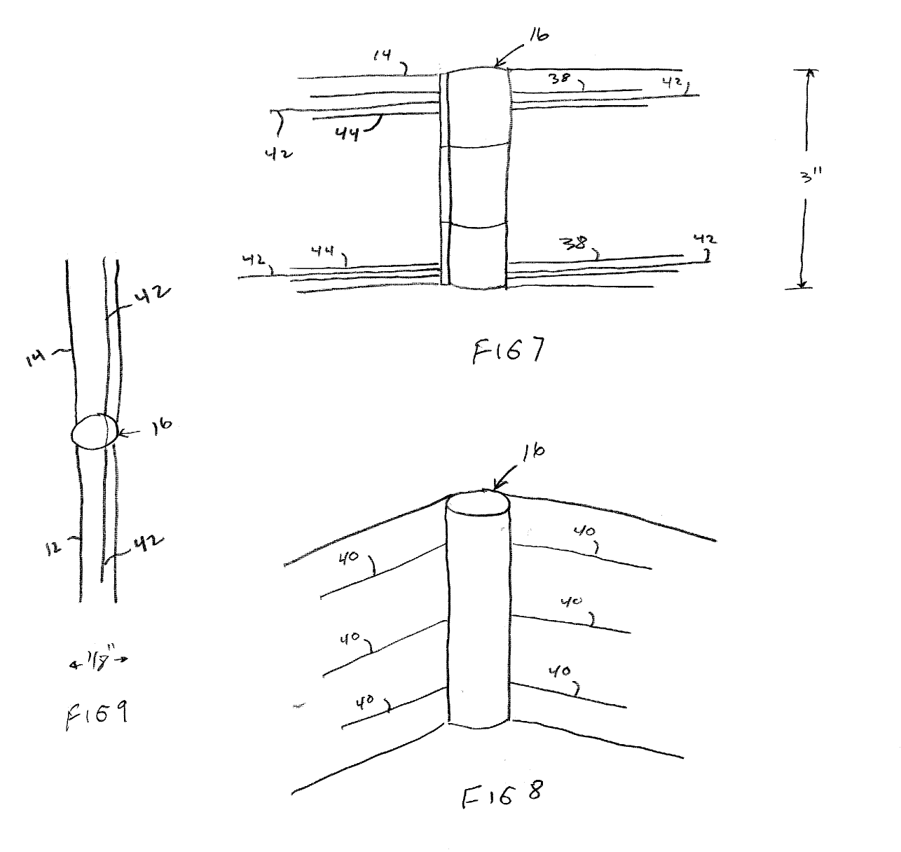

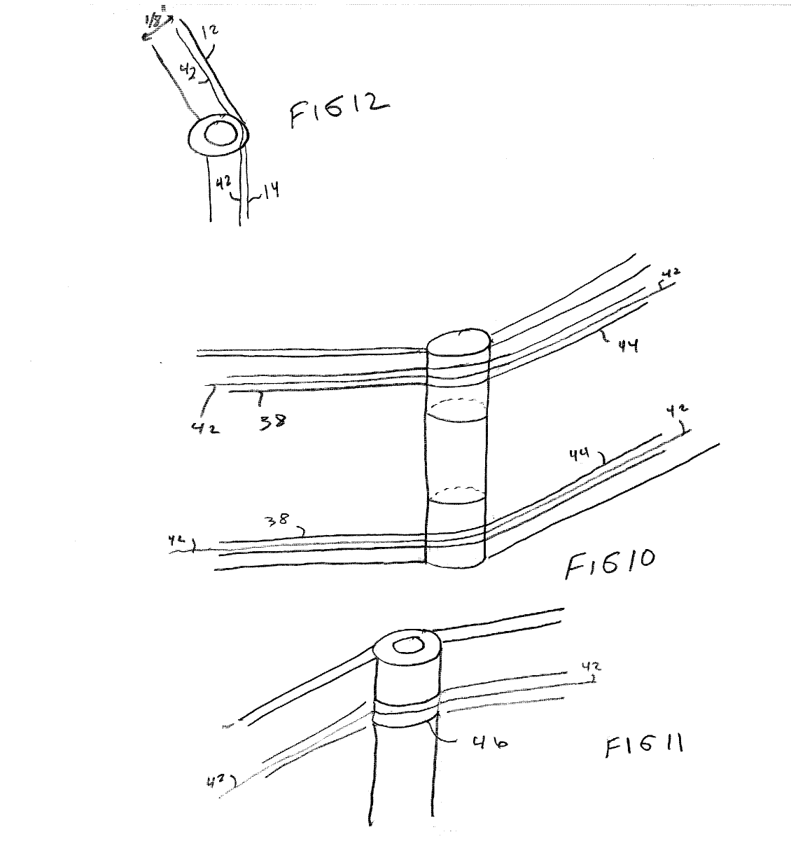

Referring now to FIG. 1, there is shown a side view of a shelf aligner apparatus in accordance with an embodiment of the invention. The shelf aligner 10 includes an arm assembly 12 and a paddle 14 moveably connected by a hinge 16. The arm assembly 12 includes a handle 18, an opening 20 and a trigger 22 disposed in the opening 20. Also included on the surface of the arm assembly and paddle are a series of calibrations, which may indicate inches or centimeters. The calibrations may be used to take measurements of distances when aligning goods on the shelf.

FIG. 2 shows a top view of the shelf aligner 10 shown in FIG. 1 in first and second positions, in accordance with an embodiment of the invention. In the first position, the paddle is in the same plane as the arm. In the second position, shown in phantom, the paddle is rotated about the hinge 90 degrees. FIG. 3 shows an enlarged top view of the tip of the paddle 14 of the shelf aligner 10 shown in FIG. 1. FIG. 3 illustrates that the tip of the paddle 14 is tapered to facilitate inserting the paddle between goods on a shelf, in accordance with an embodiment of the invention.

FIG. 4 shows a side view of a shelf aligner 24 accordance with an alternative embodiment of the invention. The shelf aligner 24 differs from the shelf aligner 10 in that it has a different handle. The shelf aligner 24 includes an arm assembly 26 and a paddle 28 moveably connected by a hinge 30. The arm assembly 26 includes a handle 32, an opening 34 and a trigger 36 disposed in the opening 34.

FIG. 5a shows a cross sectional view of the arm assembly 12 of the shelf aligner 10 shown in FIG. 1 taken at line 5a-5a in accordance with an embodiment of the invention. Cable channels 38 are shown, which extend from the handle 18 to the hinge 16. FIG. 5b shows a cross sectional view of the arm assembly of the shelf aligner shown in FIG. 5a taken at line 5b-5b showing cable channels 38 in accordance with an embodiment of the invention. Cable channels 38 provide a conduit for a pair of cables, as described below.

FIG. 6 shows a side view of the hinge 16 and springs 40 of the shelf aligner 10 shown in FIG. 1 in accordance with an embodiment of the invention. As discussed below, in one embodiment, the springs 40 are biased such that they push the paddle 14 from the angled second position towards the extended first position with respect to the arm assembly 12. In another embodiment, the springs 40 are biased such that they push the paddle 14 from the extended first position towards the angled second position with respect to the arm assembly 12.

FIG. 7 shows a side cut-away view of a portion of the arm assembly 12, the paddle 14 and the hinge 16 in accordance with an embodiment of the invention. The cable channels 38 are shown with cables 42 inserted therein. The paddle 14 is also shown in cut-away view to reveal cable channels 44 therein. The cables 42 extend from the trigger 22 through the cable channel 38 around the hinge 16 and into the paddle cable channels 44, where they are anchored near the opposite end of the paddle 14. FIG. 8 shows a side view of a hinge 16 and springs 40 of the shelf aligner 10 in accordance with an embodiment of the invention.

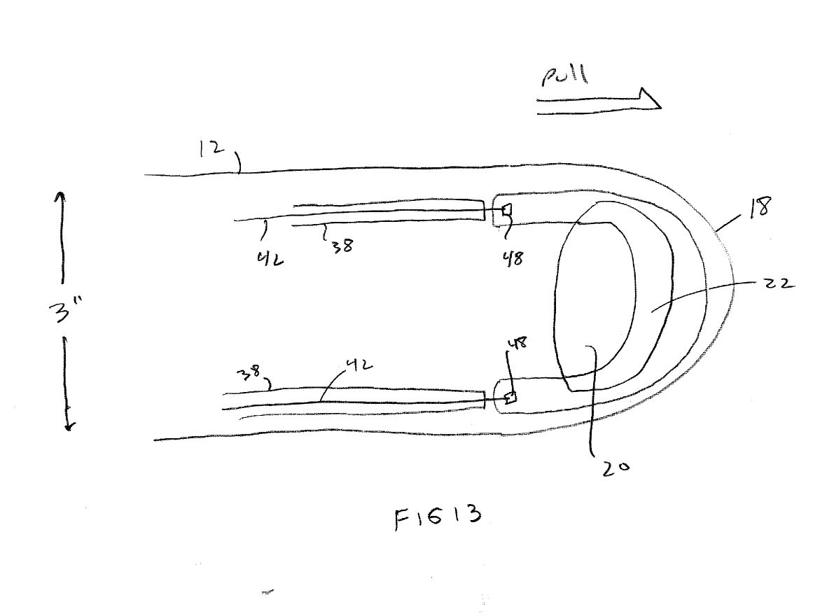

FIG. 9 shows a top cut-away view of the hinge and spring unit of the portion of the shelf aligner 10 shown in FIG. 7 in accordance with an embodiment of the invention. The cables 42 are also shown in this view. FIG. 10 shows a perspective cut-away view of a portion of the shelf aligner 10 shown in FIG. 1 in accordance with an embodiment of the invention. It can be seen that the cables 42 within the cable channels 38 extend from the arm assembly, around the hinge 16 and into the cable channels 44 within the paddle 14.

FIG. 11 shows a side view of a portion of the hinge 14 of the shelf aligner 10 in accordance with an embodiment of the invention. A pulley channel 46 disposed on the hinge 14 is shown. The pulley channel 46 is designed to control the pulley wire; keeping the wire in line during action. The channel may be enclosed or open slot, dependent upon method of production. FIG. 12 shows a top view of the hinge 16 and pulley channel 46 of the shelf aligner 10 in accordance with an embodiment of the invention. In one embodiment, pulling on the trigger causes the paddle to retract to the angled position and in another embodiment, pulling the cable causes the paddle to extend to the straight position. In the embodiment shown in FIG. 12, using the trigger to pull the cables 42, will straighten the paddle. In an embodiment where it is desired for the pulling of the trigger to retract the paddles, the cable 42 and the springs 40 may be disposed on the opposite side of the hinge.

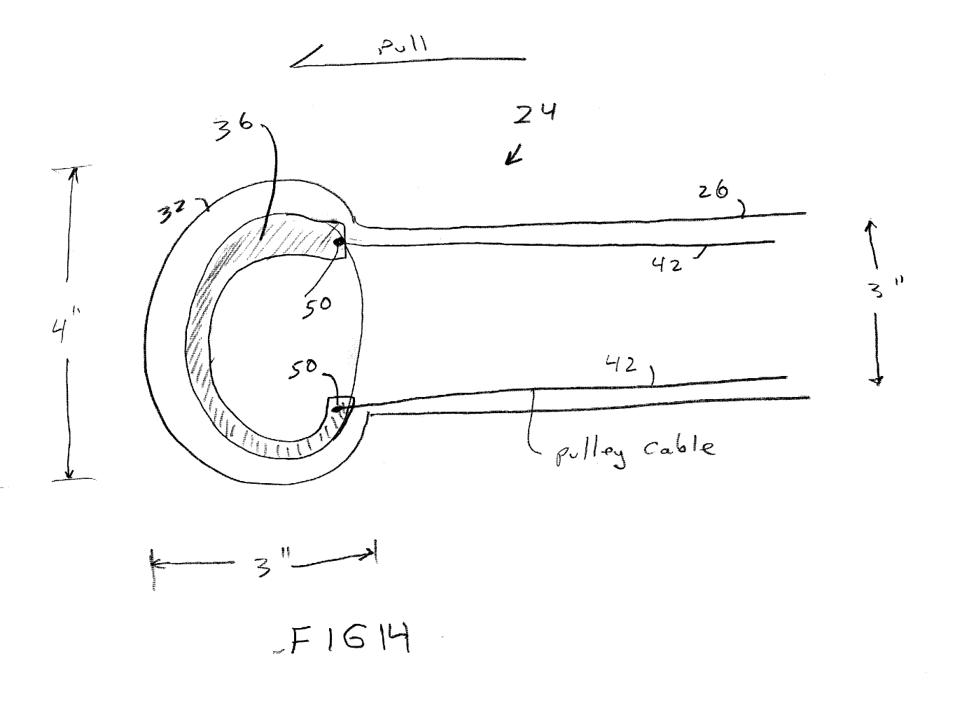

FIG. 13 shows a side view of the handle portion of the shelf aligner 10 in accordance with an embodiment of the invention. The trigger 22 is shown having anchors 48 for attachment of one end of the cables 42. Similarly, FIG. 14 shows a side view of the handle portion of the shelf aligner 24 as shown in FIG. 4 having the alternative handle design. The cable anchors 50 are shown attached to each end of the cables 42.

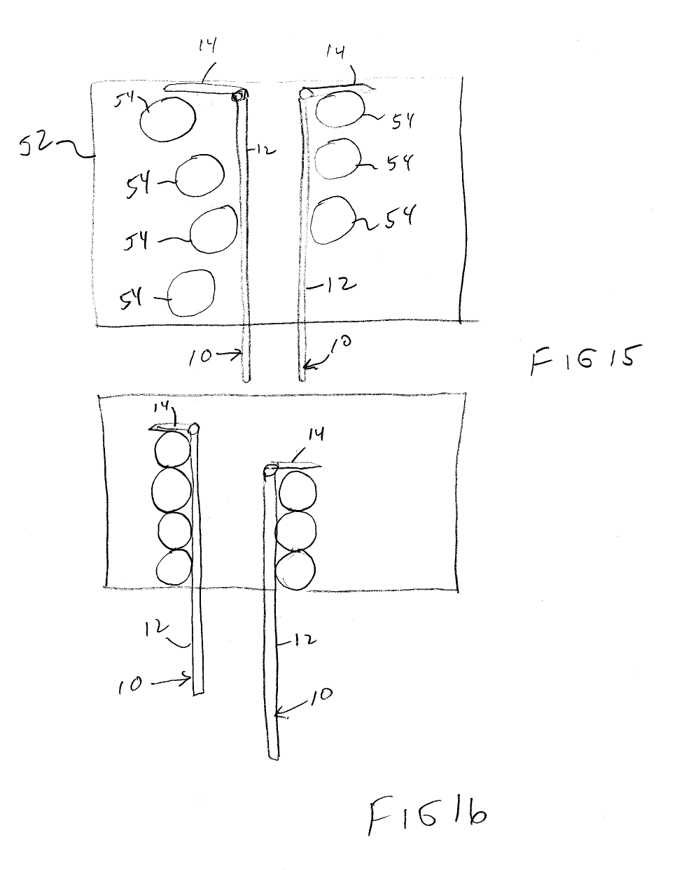

Referring now to FIG. 15, there is shown a shelf 52 having a plurality of canned goods 54. It can be seen that the canned goods are not lined up evenly and are not disposed towards the front of the shelf. It is desired to straighten out the rows of canned goods and to arrange them toward the front of the shelf. In use, the shelf aligner 10 may be inserted between the rows of goods without the trigger pulled and the paddle 14 in the first extended position (not shown). Once inserted into a desired position near the rear of the shelf, the trigger 22 may be pulled by the user and the paddle 14 moved to the angled position by action of the cables 42 pulling on the paddle 14. As shown in FIG. 16, the arm 12 may be moved to the side to line up the canned goods 54 in a straight line. The shelf aligner 10 may then be pulled toward the user so until the first can 54 is near the edge of the front of the shelf, as shown in FIG. 16. Once the cans are lined up, the trigger 22 may then be pulled so that the paddle is in the extended first position and the shelf aligner 10 may be removed from the shelf without disturbing the alignment of the canned goods 54.

In one embodiment of the invention, the total length of the shelf aligner 10 with the paddle in the extended position may be about 22 inches. In order to facilitate carrying and storing the shelf aligner a foldable embodiment may be employed. The folded shelf aligner may be about 11 inches in the folded position. At 11 inches it is possible, for example, for a user to carry the shelf aligner in a pocket. FIG. 17 shows a left side view of the foldable shelf aligner 60 in an unfolded position in accordance with an embodiment of the invention. In this embodiment, the foldable shelf aligner 60 differs from the shelf aligner 60 in that the arm assembly 62 is divided into a first section 64 and a second section 66 connected by a hinge 68. The other components of the foldable shelf aligner are the same as the shelf aligner 10 described above.

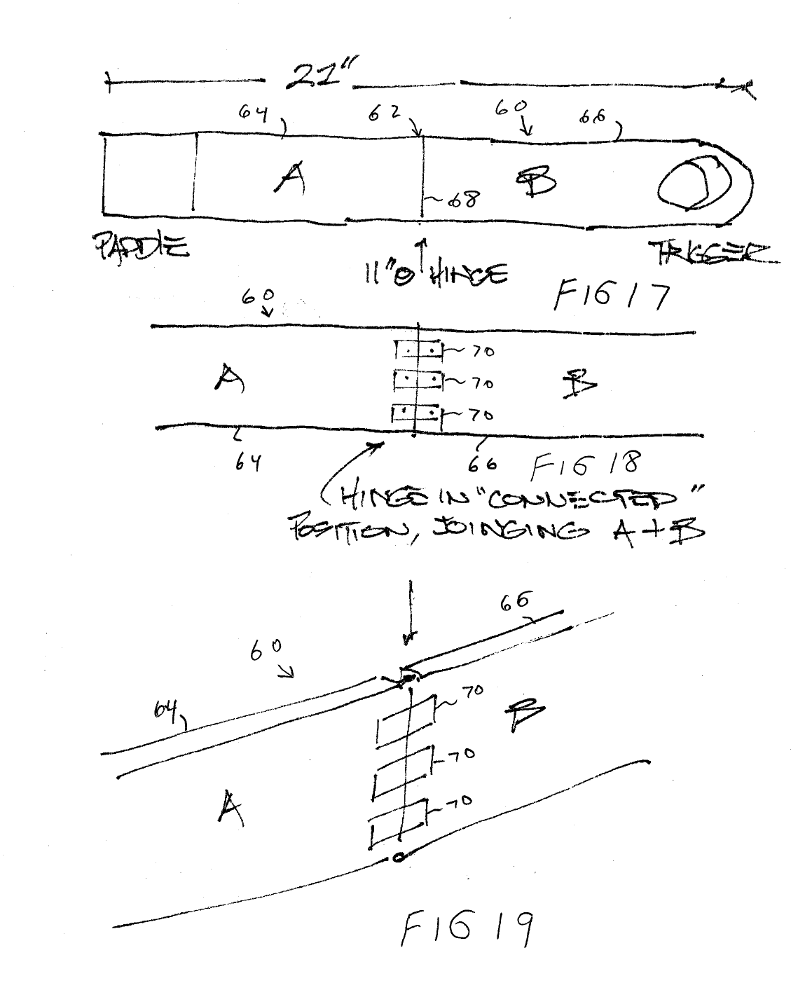

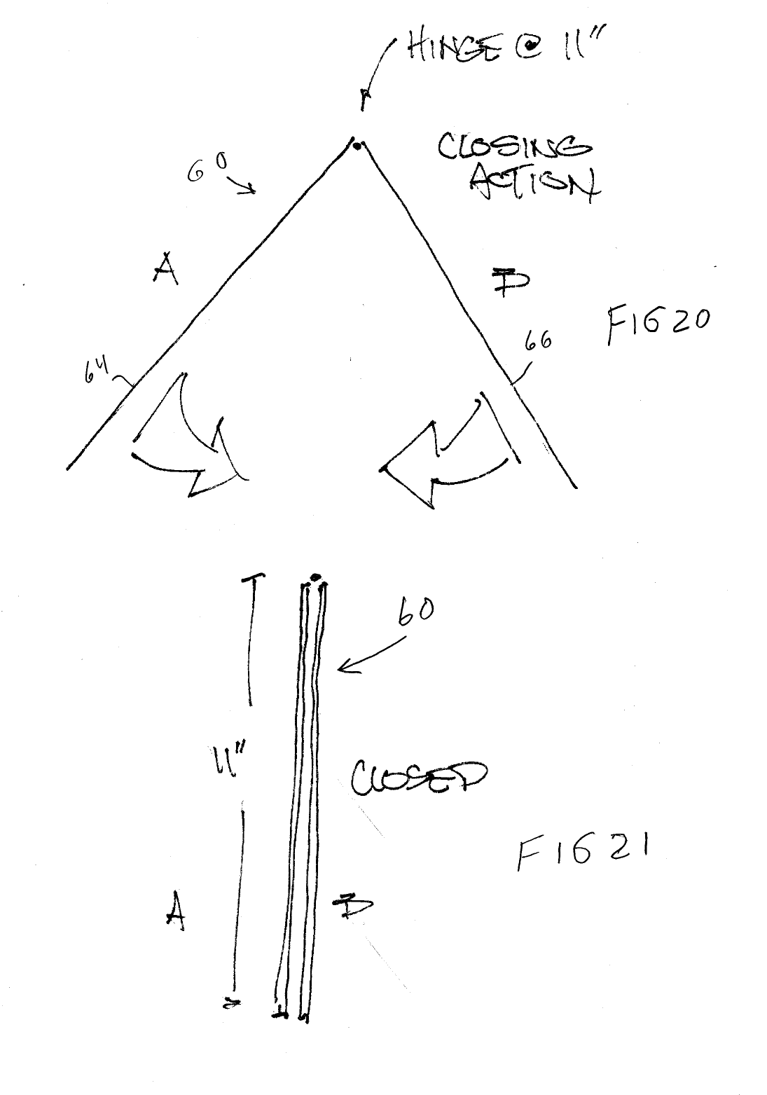

FIGS. 18 and 19 each show details of the left side view of the foldable shelf aligner 60 in an unfolded position in accordance with an embodiment of the invention. The hinge 68 may include three individual hinges 70.

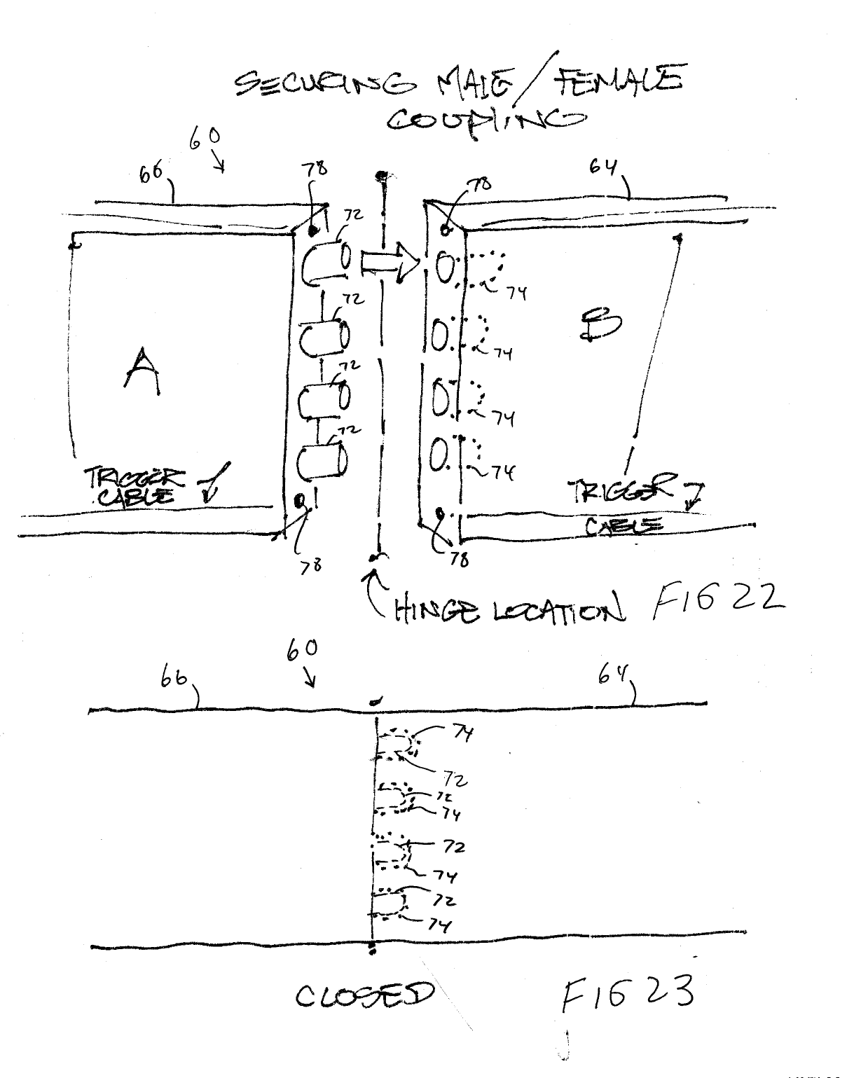

FIG. 20 shows a top view of the foldable shelf aligner 60 in a partially folded position in accordance with an embodiment of the invention. FIG. 21 shows a top view of the foldable shelf aligner 60 in a fully folded position in accordance with an embodiment of the invention.

FIG. 22 shows a right side view of a portion of the two main sections 64, 66 of the foldable shelf aligner 60 in a folded position in accordance with an embodiment of the invention. In order to provide structural strength to the foldable shelf aligner 60 when in the unfolded position, a series of cylindrical couplers 72 are located in the end of section 66 of the arm assembly 62. A corresponding series of openings 74 are provided in the adjacent end of the first section 64 of the arm assembly 62. FIG. 23 shows a right side view of a portion of the two main sections of the foldable shelf aligner 60 in a folded position. Couplers 72 fit snugly inside the openings 74.

As can be seen from the above disclosure, embodiments of the invention provide an apparatus for aligning products on shelves. It will be appreciated by one skilled in the art that aspects of the present invention may be embodied as an apparatus or as a method. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An organizing apparatus comprising:
a flat elongated arm unit having a handle at one end and a hinge at the other end;
a trigger attached to said handle;
a flat paddle attached to said hinge; and
a cable connecting said trigger to said paddle, wherein in a first position of said trigger, said paddle is aligned in the plane of said arm unit and in a second position of said trigger, said paddle is disposed at an angle with respect to the plane of said arm unit.

2. The organizing apparatus according to claim 1 further comprising a spring attached to said hinge and to said paddle, said spring being biased to bring said trigger and said paddle into said second position.

3. The organizing apparatus according to claim 1 wherein said arm unit includes a channel for said cable.

4. The organizing apparatus according to claim 1 wherein said cable is attached at one end to said trigger and at the other end to said paddle.

5. The organizing apparatus according to claim 1 said arm unit includes an opening and wherein said trigger is disposed inside said opening.

6. The organizing apparatus according to claim 1 wherein paddle is disposed at a 90 degree angle with said arm unit when in said second position.

7. The organizing apparatus according to claim 1 further comprising a second cable parallel to said first cable.

8. The organizing apparatus according to claim 1 further comprising a series of calibration markings along the surface of said arm unit for use in taking measurements.

9. A method for organizing items on a shelf comprising:
pulling a trigger on a proximal end of an elongated arm of a shelf organizing apparatus causing a paddle on the distal end of said arm to move to a first position parallel to said arm from a second position at an angle with and towards a first side of said arm;
inserting the shelf organizing apparatus between rows of goods on a shelf;
releasing said trigger thereby causing said paddle to move from said first position to said second position; and
moving said goods toward the front of said shelf using said paddle.

10. The method according to claim 9 further comprising:
pulling said trigger thereby causing said paddle to return to said first position; and
removing said elongated arm from said rows of goods on a shelf.

11. The method according to claim 9 further comprising:
flipping said shelf organizing apparatus to an inverted position;
pulling said trigger causing said paddle to move to said first position parallel to said arm from said second position at an angle with and towards a second side of said arm;
inserting the elongated arm of said shelf organizing apparatus between rows of goods on a shelf;
releasing said trigger causing said paddle to move from said first position parallel to said arm to said second position at an angle with and towards a second side of said arm; and
moving additional goods toward the front of said shelf using said paddle.

12. The method according to claim 9 further comprising, with said elongated arm inserted between rows of goods on a shelf, moving said arm toward one side to cause said goods to line up evenly against said arm.

13. The method according to claim 9 further comprising:
pulling a trigger on a proximal end of an elongated arm of a second shelf organizing apparatus causing a second paddle on the distal end of said arm to move to a first position parallel to said arm from a second position at an angle with and towards a first side of said arm;
inserting the elongated arm of said second shelf organizing apparatus between rows of goods on a shelf;
releasing a second trigger on a proximal end of said elongated arm of said second shelf organizing apparatus causing a second paddle on the distal end of said arm to move from a first position parallel to said arm to a second position at an angle with and towards a first side of said arm; and
moving said goods toward the front of said shelf using said second paddle.

14. A handheld organizing apparatus comprising:
a flat elongated arm unit having a handle with an opening at one end and a hinge at the other end;
a trigger disposed in said opening in said handle;
a flat paddle attached to said hinge;
a spring attached to said hinge and to said paddle, said spring being biased to bring said trigger and said paddle into a second position; and
a cable disposed in a channel within said arm and connecting said trigger to said paddle, wherein in said first position, said paddle is aligned in the plane of said arm unit and in said second position, said paddle is disposed at approximately a 45 degree angle with respect to the plane of said arm unit.

15. The handheld organizing apparatus according to claim 14 wherein the tip of said paddle is tapered.

16. The handheld organizing apparatus according to claim 14 wherein said spring includes a plurality of torsion springs.

17. The handheld organizing apparatus according to claim 14 wherein said plurality of torsion springs each include a first elongated portion adjacent to said arm unit, a looped circular portion encircling said hinge, and a second elongated portion adjacent to said paddle.

18. The handheld organizing apparatus according to claim 14 said arm unit includes an opening and wherein said trigger is disposed inside said opening.

19. The handheld organizing apparatus according to claim 14 wherein paddle is disposed at a 90 degree angle with said arm unit when in said second position.

20. The handheld organizing apparatus according to claim 14 wherein said elongated arm unit includes a first and second separable portions connected by a second hinge, whereby the handheld organizing apparatus may be folded reducing its overall length by about one half.
